(19) United States
(12) Patent Application Publication
(10) Pub. No.: US 2006/0091022 A1
(43) Pub. Date: May 4, 2006

(54) Nanoelectrocatalytic gas sensors for harsh environments

(75) Inventors: James Anthony Ruud, Delmar, NY (US); Mohan Manoharan, Niskayuna, NY (US); Sergio Paulo Martins Loureiro, Saratoga Springs, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 10/980,453

(22) Filed: Nov. 3, 2004

(51) Int. Cl. C25B 3/00; G01N 27/26

(52) U.S. Cl. 205/775; 204/426; 205/427; 205/425

(57) ABSTRACT

A sensor for detecting gases, such as gaseous combustion products in a hot gas path. The sensor has at least one electrode pair that includes a plurality of nanostructures. The nanostructures comprise electrocatalytic material and have a porosity that permits gases to diffuse into interior spaces within the nanostructures. A sensor system that incorporates such sensors and controls combustion parameters based upon the output generated by the sensors, and a method of detecting gases using the sensors and sensor system are also disclosed.

### BACKGROUND OF INVENTION

The invention relates to a sensor for detecting gases in a hot gas path. More particularly, the invention relates to a sensor for detecting gaseous combustion products in a hot gas path. Even more particularly, the invention relates to a sensor having an electrode pair having nanostructures for detecting gaseous combustion products in a hot gas path.

Process heating equipment based on the consumption of fossil fuels is used in a wide range of industries. Process heat is used in the petroleum and chemical industries to heat liquid material streams in chemical reactors. The steel, aluminum, and glass industries rely on furnaces for melting and reheating materials in processing operations. Aside from manufacturing, structures such as boilers and turbines burn fossil fuels to generate power or provide propulsion.

Combustion burners in process heaters are typically controlled using adjustments in the air-to-fuel ratio without real-time, online diagnostics. Multiple burner units rarely have sensors capable of measuring performance of individual burners. As a result, burner tuning and balancing is difficult to perform during operation of the process heater. Burners are often run with excess air, which reduces energy efficiency, and the variation in burner performance can lead to operating the ensemble of burners at the settings of the lowest performing burner.

Emission sensors are often used to ensure efficiency and monitor gaseous and emissions emanating from combustion burners. Such emissions sensors are usually limited by performance of their component materials in harsh combustion environments. Sensors must be able to operate sustainably at temperatures above 600° C. in order to allow measurement of individual burner characteristics. For present combustion systems, gas sensitivities on the order of 10 ppm are required. While these sensitivities are within the range of conventional zirconia-based sensors, this level of sensitivity is not sustainable for an appreciable amount of time.

The gaseous combustion environment is a very sensitive gauge of the health of the combustion process. Presently, there is no sensor technology that is capable of operating in a harsh combustion environment with the necessary sensitivity. Therefore, what is needed is a sensor that is capable of detecting gases within a combustion environment. What is also needed is a sensor that can detect gases with a high degree of sensitivity within a combustion system. Finally, what is needed is a system that provides control of a combustion system based on the output of such sensors.

### BRIEF SUMMARY OF INVENTION

The present invention meets these and other needs by providing a sensor that is capable of detecting gases, such as gaseous combustion products in a hot gas path. The sensor has at least one electrode pair that includes a plurality of nanostructures. The nanostructures comprise electrocatalytic material and have a porosity that permits gases to diffuse into interior spaces within the nanostructures. The invention also provides a sensor system that incorporates such sensors and controls combustion parameters based upon the output generated by the sensors and a method of detecting gases using the sensors and sensor system.

Accordingly, one aspect of the invention is to provide a sensor system for detecting at least one gas in a hot gas path. The sensor system comprises at least one sensor that generates an output signal that is proportional to a concentration of the at least one gas and a control system in communication with the sensor, wherein the control system receives the output signal. The sensor comprises: at least one electrode pair comprising a first sensing electrode and a second reference electrode, wherein each of the first sensing electrode and second reference electrode comprises a plurality of nanostructures, and an electrolyte layer disposed between and separating the first sensing electrode and the second reference electrode. The plurality of nanostructures comprises at least one electrocatalytic material and has a porosity that permits the at least one gas to diffuse into an interior space of the plurality of nanostructures. The plurality of nanostructures is thermally stable in a range from about 400° C. to about 1000° C.

A second aspect of the invention is to provide a sensor for detecting gases within a hot gas path. The sensor comprises: at least one electrode pair comprising a first sensing electrode and a second reference electrode, wherein each of the first sensing electrode and second reference electrode comprises a plurality of nanostructures, and an electrolyte layer disposed between and separating the first sensing electrode and the second reference electrode. The sensor generates an output signal that is proportional to a concentration of at least one gas. The plurality of nanostructures comprises at least one electrocatalytic material and has a porosity that permits the at least one gas to diffuse into an interior space of the plurality of nanostructures. The plurality of nanostructures is thermally stable in a range from about 400° C. to about 1000° C.

A third aspect of the invention is to provide a sensor system for detecting at least one gas in a combustion chamber. The sensor system comprises at least one sensor and a control system in communication with the sensor and the combustion chamber, wherein the control system receives an output signal from the at least one sensor, and wherein the control system comprises a feedback loop to control at least one combustion parameter within the combustion chamber based upon an output signal received from the at least one sensor. The sensor comprises at least one electrode pair comprising a first sensing electrode and a second reference electrode, and an electrolyte layer disposed between and separating the first sensing electrode and the second reference electrode, wherein the sensor generates an output signal between the first sensing electrode and the second reference electrode that is proportional to a concentration of at least one gas. Each of the first sensing electrode and the second reference electrode comprises a plurality of nanostructures. The plurality of nanostructures comprises at least one electrocatalytic material and has a porosity that permits the at least one gas to diffuse into an interior space of the plurality of nanostructures. The plurality of nanostructures is thermally stable in a range from about 400° C. to about 1000° C.

A fourth aspect of the invention is to provide a method of controlling a combustion process in a combustion chamber. The method comprises the steps of: providing at least one sensor for detecting gases to the combustion chamber, wherein the sensor comprises: at least one electrode pair, the electrode pair comprising a first sensing electrode and a second reference electrode, wherein each electrode comprises a plurality of nanostructures, the nano structures comprising at least one electrocatalytic material, and an electrolyte layer disposed between and separating the first electrode and the second electrode; generating an output signal from the at least one electrode pair, wherein the output signal is proportional to a concentration of at least one gas in the combustion chamber; communicating the output signal to a control system; wherein the control system comprises a feedback loop; and controlling at least one combustion parameter within the combustion chamber to control the combustion process, wherein the combustion parameter is controlled through the feedback loop based upon the output signal received from the at least one sensor.

These and other aspects, advantages, and salient features of the present invention will become apparent from the following detailed description, the accompanying drawings, and the appended claims.

### BRIEF DESCRIPTION OF DRAWINGS

FIG. 1 is a schematic representation of a sensor system of the present invention;

FIG. 2 is a schematic representation of a sensor of the present invention;

FIG. 3 is a schematic representation of a sensor capable of detecting multiple gases;

FIG. 4 is a scanning electron microscopy (SEM) image (40,000× magnification) of a self-assembled ZrO₂-based ceramic nanostructure following heat treatment at 1000° C.; and

FIG. 5 is a scanning electron microscopy (SEM) image (100,000× magnification) of a portion of the self-assembled ZrO₂-based ceramic nanostructure shown in FIG. 4.

### DETAILED DESCRIPTION

In the following description, like reference characters designate like or corresponding parts throughout the several views shown in the figures. It is also understood that terms such as “top,” “bottom,” “outward,” “inward,” and the like are words of convenience and are not to be construed as limiting terms. Furthermore, whenever a particular aspect or feature of the invention is said to comprise or consist of at least one element of a group and combinations thereof, it is understood that the aspect or feature may comprise or consist of any of the elements of the group, either individually or in combination with any of the other elements of that group.

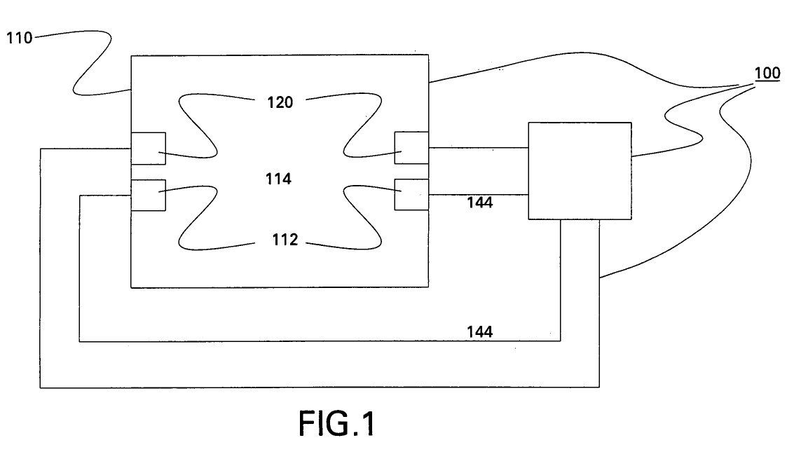

Referring to the drawings in general and to FIG. 1 in particular, it will be understood that the illustrations are for the purpose of describing a preferred embodiment of the invention and are not intended to limit the invention thereto. Turning to FIG. 1, a sensor system 100 of the present invention is shown. As seen in FIG. 1, sensor system 100 is deployed in a combustion system 110 having a plurality of combustors 112 disposed in a hot gas path 114. Combustion system 110 may include processing heating equipment that consumes fossil fuels, such as those used in the chemical, petroleum, glass, steel, aluminum, and other metals refining processes. Alternatively, combustion system 110 may be used in conjunction with power generation or propulsion. For example, combustion system 110 may be a boiler or a turbine assembly, such as, but not limited to, a gas turbine used for power generation, a turbine used for marine propulsion, or an aircraft engine.

Sensor system 100 detects at least one gas that is present in hot gas path 114 of combustion system 110. Sensor system 100 comprises at least one sensor 120 that generates an output signal that is proportional to a concentration of the at least one gas and a control system 140 that is in communication with the sensor and receives the output signal generated by sensor 120.

Sensor system 100 may comprise a single sensor 120 or, alternatively, multiple sensors. Where more than one sensor 120 is included in sensor system 100, the sensors may be identical to each other, or may be capable of detecting different gases within combustion system 110. For example, sensor system 100 may include a first sensor 120 that is capable of detecting carbon monoxide (CO), a second sensor 120 capable of detecting hydrocarbons (HCs), and a third sensor 120 that is sensitive to nitrogen-oxygen compounds (NOx). Alternatively, a single sensor 120 may be capable of detecting the presence of multiple gaseous species, such as, but not limited to, the species mentioned above. In one embodiment, sensor 120 is capable of sensing at least one of NOₓ, where 1≦x≦3; SOₓ, where 1≦x≦2; CO; CO₂, and hydrocarbons, such as alkanes, alkenes, alkynes, and the like.

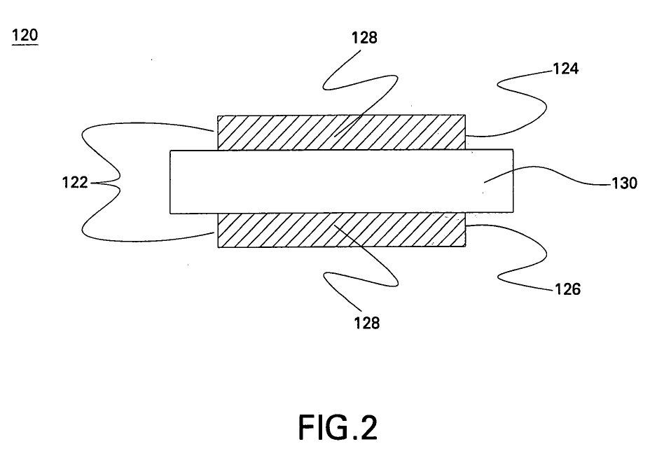

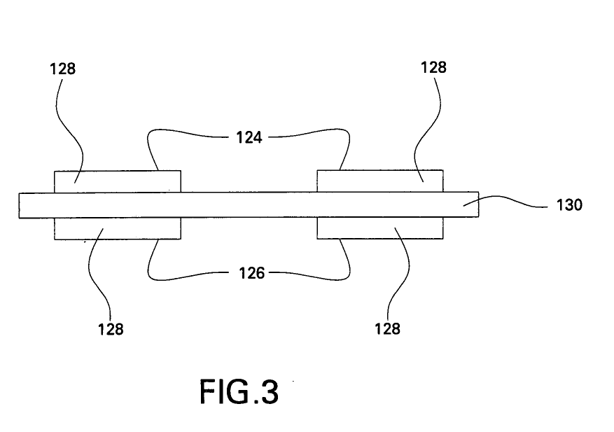

A schematic representation of sensor 120 is shown in FIG. 2. Sensor 120 comprises at least one electrode pair 122. Sensor 120 generates an output signal that is proportional to a concentration of at least one gas. In one embodiment, sensor 120 includes more than one electrode pair 122. A combined mixed potential gas sensor having more than one electrode pair and being capable of detecting multiple gases is schematically shown in FIG. 3.

Electrode pair 122 comprises a first sensing electrode 124 and a second reference electrode 124. Both first sensing electrode 124 and second reference electrode 124 comprises a plurality of nanostructures 128. Each of the nanostructures 128 comprises at least one electrocatalytic material and has a porosity that permits the gaseous species to diffuse into an interior space within each of the plurality of nanostructures 128. Each of the plurality of nanostructures 120 is thermally stable in a range from about 400° C. to about 1000° C. In one embodiment, the nanostructures are thermally stable in a range from about 400° C. to about 800° C.

Porous electrode structures composed of materials with different electrocatalytic activities are fabricated on opposite sides of a zirconia-based ionic conductor. The at least one electrocatalytic material comprises at least one of a noble metal, a mixed metal oxide, combinations thereof, or the like. In one embodiment, the mixed metal oxide includes at least one oxide having a crystal structure that contains at least one cation having a mixed oxidation state; an oxide having a crystal structure that is capable of forming an anionic defect, such as an oxygen deficiency or overstoichiometry; and combinations of any of these two types of oxides. The electrocatalytic material may comprise mixed metal oxides such as perovskites, brownmillerites, pyrochlores, spinels, inverse spinels, combinations thereof, and the like. Examples of mixed metal oxides having a crystal structure that contains at least one cation having at least one of a mixed oxidation state, an anionic deficiency, and overstoichiometry include, but are not limited to, oxides having formulas such as (AB)(CD)O_{3±δ}; (AB)₂(CD)₂O_{6±δ}; (AB)(CD)₂O_{4±δ}; and the like, where A is one of bismuth, lanthanum, gallium, calcium, cerium, strontium, barium, yttrium, ytterbium, samarium, neodymium, gadolinium, cadmium, tungsten, zirconium, hafnium, and niobium; B is one of calcium, strontium, and barium; and C and D are, independent of each other, one of vanadium, chromium, manganese, iron, cobalt, nickel, copper, zinc, zirconium, niobium, molybdenum, ruthenium, rhodium, rhenium, osmium, and iridium. Non-limiting examples of noble metals that may be present in the electrocatalytic material include platinum, palladium, silver, ruthenium, rhodium, rhenium, iridium, and gold. In another embodiment, the plurality of nanostructures 128 further comprises at least one electrolyte. The electrolyte comprises at least one of: stabilized zirconia, including calcia-stabilized, magnesia-stabilized, yttria-stabilized and scandia-stabilized zirconia; ceria, including samaria-doped ceria and gadolinia-doped ceria; bismuth oxide, including erbia-doped bismuth oxide; and gallium oxides, including lanthanum-strontium-magnesium-gallates.

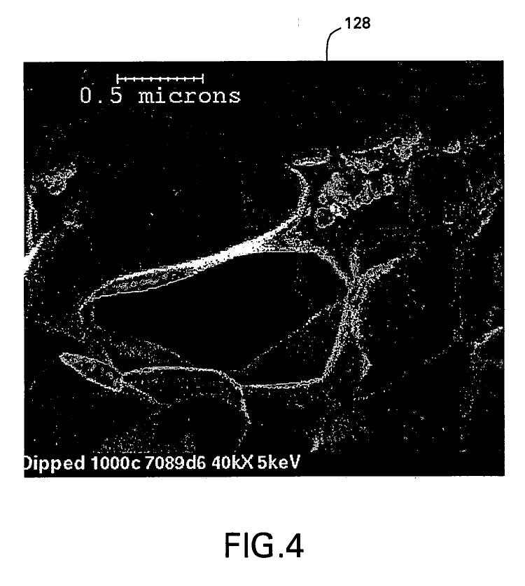

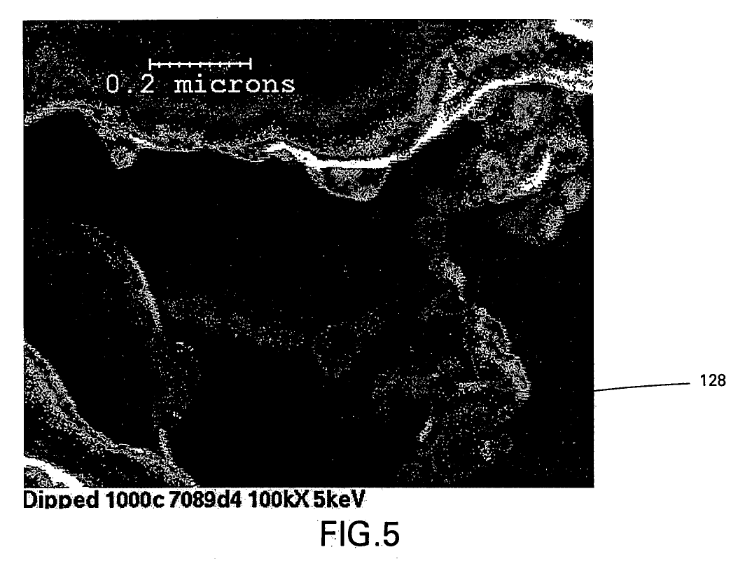

In one embodiment, the plurality of nanostructures 128 comprises at least one of nanorods, nanospheres, nanodiscs, nanobelts, nanoribbons, combinations thereof, and the like. Nanostructures are understood to be primary crystallites of compositions such as those described above for the electrolyte and the electrocatalytical material, wherein the average primary crystallite size is in a range from about 10 nm to about 500 nm. Each of the plurality of nanostructures 128 has at least one dimension in a range from about 10 nm to about 500 nm. In one embodiment, each nanostructure 180 has at least one dimension in a range from about 20 nm to about 200 nm. In another embodiment, each nanostructure 128 has at least one dimension in a range from about 50 nm to about 100 nm. The average crystallite size may be determined by x-ray powder diffraction or transmission electron microscopy. Examples of such nanostructures 128 are shown FIGS. 4 and 5, which are SEM images of self-assembled ZrO₂-based ceramic nanostructures following heat treatment at 1000° C.

Nanostructures 128 may be formed by a variety of techniques such as but not limited to: infiltration and in situ growth of ceramic nanoparticles by self-assembly and templating methods on a microporous electrode; compaction and sintering of ceramic nanopowders with different fillers or binders of different particle size; forming a ceramic membrane having a continuous porosity that exhibits increasing levels of tortuosity; and forming an ultrafine, highly porous aerogel comprising cross-linked ceramic nanoparticles. Nanoparticles of electrocatalytic materials may be produced by a variety of synthetic methods, including sol-gel methods, self-assembly and temptation with neutral surfactants, controlled double-jet precipitation, polyvinyl alcohol (PVA) steric entrapment, bicine precipitation, and the like.

First sensing electrode 124 and second reference electrode 126 are separated from each other by an electrolyte layer 130. Electrolyte layer 130 comprises at least one metal oxide selected from the group consisting of bismuth oxide, lanthanum oxide, gallium oxide, calcium oxide, cerium oxide, strontium oxide, barium oxide, yttrium oxide, ytterbium oxide, samarium oxide, neodymium oxide, gadolinium oxide, cadmium oxide, tungsten oxide, zirconium oxide, hafnium oxide, niobium oxide, and combinations thereof.

The nonequilibrium potential between first sensing electrode 124 and second reference electrode 126 is determined by the kinetics of the oxidation and reduction processes that occur on the surface area of the electrodes. The sensor output, ΔE, is determined from the sensed gas concentration, Cᵢ, by the following expression:
ΔE=E₀−KRTDᵢAᵥdCᵢ
where E₀ is a reference potential, K and R are constants, T is temperature, Dᵢ is the gas diffusion coefficient, Aᵥ is the volume-specific electrode area of first sensing electrode 124, and d is the thickness of first sensing electrode 124. The sensitivity of sensor 120 is determined from the differential catalytic activities of the electrode materials comprising each of first sensing electrode 124 and second reference electrode 126 and the surface area that is available for the reaction between gases and each of first sensing electrode 124 and second reference electrode 126.

Sensitivity of sensor 120 is enhanced by increasing the specific surface areas of first sensing electrode 124 and second reference electrode 126, which in turn enhance the reactivity of the electrodes with gaseous species within combustion chamber 110. Stability of sensor 120 is enhanced by maintaining a stable surface area; i.e., the surface area does not undergo significant microstructural changes within the operating regime of sensor 120. However, it is desirable that gas diffusivity through out the electrodes is not reduced.

In one embodiment, at least one of first sensing electrode 124 and second reference electrode 124 is functionalized by providing a nanoscale material having an electrocatalytical activity to a basic ceramic nanostructure. Alternatively, at least one of first sensing electrode 124 and second reference electrode 124 is functionalized by forming the entire ceramic nanostructure from the above-mentioned nanoscale material having an electrocatalytical activity. One ceramic nanostructure for first sensing electrode 124 and second reference electrode 124 has large pore channels for gas transport through the bulk of the electrode, with nano-sized surface sites for gas reactivity. The ceramic nanostructure has at least ten times the surface area of conventional ceramic electrodes and is stable at temperatures above about 750° C. Examples of such ceramic nanostructures are shown FIGS. 4 and 5. FIGS. 4 and 5 are SEM images of self-assembled ZrO₂-based ceramic nanostructures following heat treatment at 1000° C. The ceramic nanostructure shown in FIGS. 4 and 5 retains its high surface area after exposure to high temperature. The ceramic nanostructure is capable of being functionalized by a range of electrode material pairs to provide dissimilar nonequilibrium electrodes capable of sensing NOx, CO, SOx, and hydrocarbons.

In order to optimize mechanical and thermal performance, it is desirable to control the formation of defects in ceramic materials. Ceramics have been made by consolidating and sintering ceramic powders. However, it is difficult to retain nanostructures at the sintering temperature, even if the original powders were at the nanoscale.

Templated synthesis of nanostructures offers the ability to engineer high-surface area, high-reactivity electrodes. Stabilization of ceramic nanostructures at high temperatures may be achieved through dual-phased architectures or microstructures, as well as by related concepts. Crystal chemistry engineering allows properties to be tuned on a molecular scale. The environment surrounding one or more particular sites of the crystal structure may be modified to provide an engineered property. For example, the electrical conductivity of a material may be engineered by altering the electronic band structure of the crystal lattice. In another example, anionic conductivity may be engineered by modifying the defect structure of the crystal lattice. These properties, as well as others, may be modified by chemical substitution at specific sites in the crystal lattice. Such substitution may be either partial or complete; the degree of substitution is sufficient to achieve the desired change in properties.

As described hereinabove, oxidation and reduction reactions occurring between gaseous species and the at least one electrocatalytic material of nanostructures generate a potential between first sensing electrode 124 and second reference electrode 126. The potential comprises the output signal of sensor 120, which is received by control system 140. Control system 140 is in communication with sensor 120. In one embodiment, control system 140 is electrically connected to sensor 120 by means that are known in the art, such as, for example, an electrical circuit that includes electrically conductive wires or cables. Here, the output signal generated by sensor 120 is either a voltage or current. In another embodiment, sensor 120 generates an optical signal and is coupled to control system 140 by fiber optics. Control system 140 need not be directly coupled to sensor 120. Instead, at least a portion of control system 140 may be located remotely from sensor 120 and combustion system 110. For example, a portion of control system 140 may be located in a control room or cockpit. In such instances, communication between sensor 120 and control system 140 may comprise remote communication means that are well known in the art, such as optical, acoustical, and wireless communication systems and the like. Here, a signal corresponding to the potential detected between first sensing electrode 124 and second reference electrode 126 is transmitted to control system 140, which receives the signal and then records and measures the potential.

In one embodiment, control system 140 further includes at least one feedback loop to control at least one combustion parameter within the combustion chamber of hot gas path 114. The feedback loop acts to adjust at least one combustion parameter based upon the output signal received from sensor 120. In order to adjust the combustion parameters, the feedback loop is typically in communication with those portions of combustion system 110 that control the combustion process. For example, control system is in communication through the feedback loop with at least one of the mechanisms that control the intake of fuel and oxidizer (such as, for example, air) into the combustion chamber of combustion system 110. Such communication is established by means that are known in the art, such as those used to establish communication between control system 140 and sensor 120. Based on the output of sensor 120 that is received by control system 140, a signal is transmitted through the feedback loop to combustion system 110 to make adjustments to combustion parameters, such as those referred to above.

Several control systems may be used for control of air and fuel for combustion systems. Such control systems and feedback loops that are adapted to receive an output signal and control a process based upon such a signal are well known in the art and will not be described in detail here. In one embodiment, control system 140 comprises fixed position parallel controls that use a single positioner to regulate both the air and fuel flows. The single positioner does not allow independent control of the air and fuel flows. In another embodiment, control system 140 comprises parallel positioning control systems that use individual positioners for the air and fuel flows with electronic end-device positioning signals to guarantee accurate flow regulation. The parallel positioning control system permits independent control of fuel and airflows. Alternatively, series metered control systems regulate both air and fuel flow through linked meter set points. A set point is established for the airflow controller, cascaded to the fuel controller as a remote set point, and adjusted to achieve a specific fuel-air ratio using a ratio algorithm signal. In another embodiment, metered parallel positioning control systems control fuel and air loops from a single set point with the air set point ratio used to achieve the air/fuel ratio. Cross-limited parallel metered control systems use an interlocking fuel-air ratio control logic to maintain the air/fuel ratio within a band of high and low set points. Cross-limited parallel metered control systems represent the most dynamic combustion control strategy that can be used for systems with large load swings, and provide accurate control during steady state operation.

In one non-limiting example, combustion burners in a process heater, for example, are typically controlled using adjustments in the air/fuel ratio. Other parameters, such as combustion product pressure, combustion chamber pressure, fuel pressure, oxidizer pressure, the concentration of at least one gaseous combustion product (such as NO, NO₂, CO, or CO₂), fuel concentration, oxidizer concentration, combinations thereof, and the like, may be adjusted as well. Control system 140 receives the output the output of sensor 120 and, through the feedback loop, adjusts the intake of fuel and oxidizer to either change the air/fuel ratio or maintain the ratio at a constant value.

While typical embodiments have been set forth for the purpose of illustration, the foregoing description should not be deemed to be a limitation on the scope of the invention. Accordingly, various modifications, adaptations, and alternatives may occur to one skilled in the art without departing from the spirit and scope of the present invention.

1. A sensor system for detecting at least one gas in a hot gas path, said sensor system comprising:
a) at least one sensor, the sensor comprising:
i) at least one electrode pair, the electrode pair comprising a first sensing electrode and a second reference electrode, wherein each electrode comprises a plurality of nanostructures, each of the plurality of nanostructures comprising at least one electrocatalytic material and having a porosity that permits the at least one gas to diffuse into an interior space of the plurality of nanostructures, wherein the plurality of nanostructures is thermally stable in a range from about 400° C. to about 1000° C.; and
ii) an electrolyte layer disposed between and separating the first sensing electrode and the second reference electrode, wherein the sensor generates an output signal that is proportional to a concentration of the at least one gas; and
b) a control system in communication with the sensor, wherein the control system receives the output signal.

2. The sensor system according to claim 1, wherein the hot gas path includes a combustion chamber, and wherein the control system further comprises a feedback loop to control at least one combustion parameter within the combustion chamber based upon the output signal received from the at least one sensor.

3. The sensor system according to claim 2, wherein the at least one combustion parameter comprises at least one of a fuel-to-air ratio, a combustion product pressure, a combustion chamber pressure a fuel pressure, an oxidizer pressure, a concentration of at least one gas, a fuel concentration, an oxidizer concentration, and combinations thereof.

4. The sensor system according to claim 1, wherein the at least one electrocatalytic material comprises at least one of a noble metal, a mixed metal oxide, and combinations thereof.

5. The sensor system according to claim 4, wherein the mixed metal oxide comprises at least one of a compound having a crystal structure that contains at least one cation having a mixed oxidation state, a compound having a crystal structure that is capable of forming an anionic defect by one of deficiency and overstoichiometry, and combinations thereof.

6. The sensor system according to claim 5, wherein the mixed metal oxide comprises at least one of a perovskite, a brownmillerite, a pyrochlore, a spinel, an inverse spinel, and combinations thereof.

7. The sensor system according to claim 5, wherein the mixed metal oxide comprises at least one of an alkali-earth metal, a lanthanide metal, a transition metal, and combinations thereof.

8. The sensor system according to claim 7, wherein the alkali-earth metal is one of calcium, strontium, and barium.

9. The sensor system according to claim 7, wherein the transition metal is one of vanadium, chromium, manganese, iron, cobalt, nickel, copper, zinc, zirconium, niobium, molybdenum, ruthenium, rhodium, rhenium, osmium, and iridium.

10. The sensor system according to claim 4, wherein the noble metal is one of platinum, palladium, silver, ruthenium, rhodium, rhenium, iridium, and gold.

11. The sensor system according to claim 1, wherein the plurality of nanostructures comprises at least one of nanorods, equiaxial nanostructures, non-equiaxial nanostructures, nanospheres, nanodiscs, nanobelts, nanoribbons, and combinations thereof.

12. The sensor system according to claim 1, wherein each of the plurality of nanostructures comprises at least one crystallite, and wherein the at least one crystallite has a dimension in a range from about 10 nm to about 500 nm.

13. The sensor system according to claim 12, wherein the dimension is in a range from about 20 to about 200 nm.

14. The sensor system according to claim 12, wherein the dimension is in a range from about 50 to about 100 nm.

15. The sensor system according to claim 1, wherein the plurality of nanostructures further comprises at least one electrolyte.

16. The sensor system according to claim 15, wherein the at least one electrolyte comprises at least one metal oxide selected from the group consisting of bismuth oxide, lanthanum oxide, gallium oxide, calcium oxide, cerium oxide, strontium oxide, barium oxide, yttrium oxide, ytterbium oxide, samarium oxide, neodymium oxide, gadolinium oxide, cadmium oxide, tungsten oxide, zirconium oxide, hafnium oxide, niobium oxide, and combinations thereof.

17. The sensor system according to claim 15, wherein the at least one electrolyte comprises at least one of bismuth oxide, gallium oxide, cerium oxide, zirconium oxide, lanthanum oxide, strontium oxide, barium oxide, and combinations thereof.

18. The sensor system according to claim 1, wherein the electrolyte layer comprises at least one oxide ion conductor selected from the group consisting essentially of a stabilized-zirconia, ceria, a doped-ceria, a stabilized bismuth oxide, lanthanum gallate, a doped lanthanum gallate, and combinations thereof.

19. The sensor system according to claim 18, wherein the stabilized ceria comprises at least one of samaria-doped ceria, gadolinia-doped ceria, yttria-doped ceria, lanthana-doped ceria, calcia-doped ceria, strontia-doped ceria, and combinations thereof.

20. The sensor system according to claim 18, wherein the stabilized bismuth oxide comprises at least one of a neodymia-doped bismuth oxide, a lanthana-doped bismuth oxide, an yttria-doped bismuth oxide, an erbia-doped bismuth oxide, a gadolinia-doped bismuth oxide, a dysprosia-doped bismuth oxide, a calcia-doped bismuth oxide, a strontia-doped bismuth oxide, and combinations thereof.

21. The sensor system according to claim 18, wherein the doped lanthanum gallate comprises at least one of a strontia-doped lanthanum gallate, a magnesia-doped lanthanum gallate, and combinations thereof

22. The sensor system according to claim 18, wherein the at least one oxide comprises at least one stabilized zirconia.

23. The sensor system according to claim 22, wherein the at least one stabilized zirconia comprises at least one of calcia-doped zirconia, magnesia-doped zirconia, yttria-doped zirconia, gadolinia-doped zirconia, ytterbia-doped zirconia, scandia-doped zirconia, and combinations thereof.

24. The sensor system according to claim 1, wherein the sensor is capable of sensing at least one of NOₓ, where 1≦x≦3; SOₓ, where 1≦x≦2; CO; CO₂, and at least one hydrocarbon.

25. The sensor system according to claim 1, wherein the plurality of nanostructures is thermally stable in a range from about 500° C. to about 800° C.

26. A sensor for detecting gases within a hot gas path, the sensor comprising:
a) at least one electrode pair, the electrode pair comprising a first sensing electrode and a second reference electrode, wherein each of the first sensing electrode and the second reference electrode comprises a plurality of nanostructures, the plurality of nanostructures comprising at least one electrocatalytic material and having a porosity that permits the at least one gas to diffuse into an interior space of the plurality of nanostructures, wherein the plurality of nanostructures are thermally stable in a range from about 400° C. to about 1000° C.; and
b) an electrolyte layer disposed between and separating the first sensing electrode and the second reference electrode, wherein the sensor generates an output signal that is proportional to a concentration of the at least one gas.

27. The sensor according to claim 26, wherein the at least one electrocatalytic material comprises at least one of a noble metal, a mixed metal oxide, and combinations thereof.

28. The sensor according to claim 27, wherein the mixed metal oxide comprises at least one of a compound having a crystal structure that contains at least one cation having a mixed oxidation state, a compound having a crystal structure that is capable of forming an anionic defect by one of deficiency and overstoichiometry, and combinations thereof.

29. The sensor according to claim 28, wherein the mixed metal oxide comprises at least one of a perovskite, a brownmillerite, a pyrochlore, a spinel, an inverse spinel, and combinations thereof.

30. The sensor according to claim 28, wherein the mixed metal oxide comprises at least one of an alkali-earth metal, a lanthanide metal, a transition metal, and combinations thereof.

31. The sensor according to claim 30, wherein the alkali-earth metal is one of calcium, strontium, and barium.

32. The sensor according to claim 30, wherein the transition metal is one of vanadium, chromium, manganese, iron, cobalt, nickel, copper, zinc, zirconium, niobium, molybdenum, ruthenium, rhodium, rhenium, osmium, and iridium.

33. The sensor according to claim 27, wherein the noble metal is one of platinum, palladium, silver, ruthenium, rhodium, rhenium, iridium, and gold.

34. The sensor according to claim 26, wherein the plurality of nanostructures comprises at least one of nanorods, equiaxial nanostructures, non-equiaxial nanostructures, and combinations thereof.

35. The sensor according to claim 26, wherein each of the plurality of nanostructures comprises at least one crystallite, and wherein the at least one crystallite has a dimension in a range from about 10 nm to about 500 nm

36. The sensor according to claim 35, wherein the dimension is in a range from about 20 to about 200 nm.

37. The sensor according to claim 35, wherein the dimension is in a range from about 50 to about 100 nm.

38. The sensor according to claim 26, wherein the plurality of nanostructures further comprises at least one electrolyte.

39. The sensor according to claim 38, wherein the at least one electrolyte comprises at least one metal oxide selected from the group consisting of bismuth oxide, lanthanum oxide, gallium oxide, calcium oxide, cerium oxide, strontium oxide, barium oxide, yttrium oxide, ytterbium oxide, samarium oxide, neodymium oxide, gadolinium oxide, cadmium oxide, tungsten oxide, zirconium oxide, hafnium oxide, niobium oxide, and combinations thereof.

40. The sensor according to claim 39, wherein the at least one electrolyte comprises at least one of bismuth oxide, gallium oxide, cerium oxide, zirconium oxide, lanthanum oxide, strontium oxide, barium oxide, and combinations thereof.

41. The sensor according to claim 26, wherein the electrolyte layer comprises at least one oxide ion conductor selected from the group consisting essentially of a stabilized-zirconia, ceria, a doped-ceria, a stabilized bismuth oxide, lanthanum gallate, a doped lanthanum gallate, and combinations thereof.

42. The sensor according to claim 41, wherein the stabilized ceria comprises at least one of samaria-doped ceria, gadolinia-doped ceria, yttria-doped ceria, lanthana-doped ceria, calcia-doped ceria, strontia-doped ceria, and combinations thereof.

43. The sensor according to claim 41, wherein the stabilized bismuth oxide comprises at least one of a neodymia-doped bismuth oxide, a lanthana-doped bismuth oxide, an yttria-doped bismuth oxide, an erbia-doped bismuth oxide, a gadolinia-doped bismuth oxide, a dysprosia-doped bismuth oxide, a calcia-doped bismuth oxide, a strontia-doped bismuth oxide, and combinations thereof.

44. The sensor system according to claim 41, wherein the doped lanthanum gallate comprises at least one of a strontia-doped lanthanum gallate, a magnesia-doped lanthanum gallate, and combinations thereof

45. The sensor system according to claim 41, wherein the at least one oxide comprises at least one stabilized zirconia.

46. The sensor according to claim 45, wherein the at least one stabilized zirconia comprises at least one of calcia-doped zirconia, magnesia-doped zirconia, yttria-doped zirconia, gadolinia-doped zirconia, ytterbia-doped zirconia, scandia-doped zirconia, and combinations thereof.

47. The sensor according to claim 26, wherein the sensor is capable of sensing at least one of NOₓ, where 1≦x≦3; SOₓ, where 1≦x≦2; CO; CO₂, and at least one hydrocarbon.

48. The sensor according to claim 26, wherein the plurality of nanostructures is thermally stable in a range from about 500° C. to about 800° C.

49. A sensor system for detecting at least one gas in a combustion chamber, said sensor system comprising:
a) at least one sensor, the at least one sensor comprising:
i) at least one electrode pair, the electrode pair comprising a first sensing electrode and a second reference electrode, wherein each of the first sensing electrode and the second reference electrode comprises a plurality of nanostructures, the plurality of nanostructures comprising at least one electrocatalytic material and having a porosity that permits the at least one gas to diffuse into an interior space of the plurality of nanostructures, wherein the plurality of nanostructures are thermally stable in a range from about 400° C. to about 1000° C.; and
ii) an electrolyte layer disposed between and separating the first sensing electrode and the second reference electrode, wherein the sensor generates an output signal that is proportional to a concentration of the at least one gas; and
b) a control system in communication with the sensor and the combustion chamber, wherein the control system receives the output signal from the at least one sensor, and wherein the control system comprises a feedback loop to control at least one combustion parameter within the combustion chamber based upon the output signal received from the at least one sensor.

50. The sensor system according to claim 49, wherein the at least one combustion parameter comprises at least one of a fuel-to-air ratio, a combustion product pressure, a combustion chamber pressure a fuel pressure, an oxidizer pressure, a concentration of at least one gas, a fuel concentration, an oxidizer concentration, and combinations thereof.

51. The sensor system according to claim 49, wherein the at least one electrocatalytic material comprises at least one of a noble metal, a mixed metal oxide, and combinations thereof.

52. The sensor system according to claim 45, wherein the mixed metal oxide comprises at least one of a compound having a crystal structure that contains at least one cation having a mixed oxidation state, a compound having a crystal structure that is capable of forming an anionic defect by one of deficiency and overstoichiometry, and combinations thereof.

53. The sensor system according to claim 46, wherein the mixed metal oxide comprises at least one of a perovskite, a brownmillerite, a pyrochlore, a spinel, an inverse spinel, and combinations thereof.

54. The sensor system according to claim 46, wherein the mixed metal oxide comprises at least one of an alkali-earth metal, a lanthanide metal, a transition metal, and combinations thereof.

55. The sensor system according to claim 54, wherein the alkali-earth metal is one of calcium, strontium, and barium.

56. The sensor system according to claim 54, wherein the transition metal is one of vanadium, chromium, manganese, iron, cobalt, nickel, copper, zinc, zirconium, niobium, molybdenum, ruthenium, rhodium, rhenium, osmium, and iridium.

57. The sensor system according to claim 51, wherein the noble metal is one of platinum, palladium, silver, ruthenium, rhodium, rhenium, iridium, and gold.

58. The sensor system according to claim 49, wherein the plurality of nanostructures comprises at least one of nanorods, equiaxial nanostructures, non-equiaxial nanostructures, and combinations thereof.

59. The sensor system according to claim 49, wherein each of the plurality of nanostructures comprises at least one crystallite, and wherein the at least one crystallite has a dimension in a range from about 10 nm to about 500

60. The sensor system according to claim 59, wherein the dimension is in a range from about 20 to about 200 nm.

61. The sensor system according to claim 60, wherein the dimension is in a range from about 50 to about 100 nm.

62. The sensor system according to claim 49, wherein the plurality of nanostructures further comprises at least one electrolyte.

63. The sensor system according to claim 62, wherein the at least one electrolyte comprises at least one metal oxide selected from the group consisting of bismuth oxide, lanthanum oxide, gallium oxide, calcium oxide, cerium oxide, strontium oxide, barium oxide, yttrium oxide, ytterbium oxide, samarium oxide, neodymium oxide, gadolinium oxide, cadmium oxide, tungsten oxide, zirconium oxide, hafnium oxide, niobium oxide, and combinations thereof.

64. The sensor system according to claim 62, wherein the at least one electrolyte comprises at least one of bismuth oxide, gallium oxide, cerium oxide, zirconium oxide, lanthanum oxide, strontium oxide, barium oxide, and combinations thereof.

65. The sensor system according to claim 49, wherein the electrolyte layer comprises at least one oxide ion conductor selected from the group consisting essentially of a stabilized-zirconia, ceria, a doped-ceria, a stabilized bismuth oxide, lanthanum gallate, a doped lanthanum gallate, and combinations thereof.

66. The sensor system according to claim 65, wherein the stabilized ceria comprises at least one of samaria-doped ceria, gadolinia-doped ceria, yttria-doped ceria, lanthana-doped ceria, calcia-doped ceria, strontia-doped ceria, and combinations thereof.

67. The sensor system according to claim 65, wherein the stabilized bismuth oxide comprises at least one of a neodymia-doped bismuth oxide, a lanthana-doped bismuth oxide, an yttria-doped bismuth oxide, an erbia-doped bismuth oxide, a gadolinia-doped bismuth oxide, a dysprosia-doped bismuth oxide, a calcia-doped bismuth oxide, a strontia-doped bismuth oxide, and combinations thereof.

68. The sensor system according to claim 65, wherein the doped lanthanum gallate comprises at least one of a strontia-doped lanthanum gallate, a magnesia-doped lanthanum gallate, and combinations thereof.

69. The sensor system according to claim 65, wherein the at least one oxide comprises at least one stabilized zirconia.

70. The sensor system according to claim 69, wherein the at least one stabilized zirconia comprises at least one of calcia-doped zirconia, magnesia-doped zirconia, yttria-doped zirconia, gadolinia-doped zirconia, ytterbia-doped zirconia, scandia-doped zirconia, and combinations thereof.

71. The sensor system according to claim 49, wherein the sensor is capable of sensing at least one of NOₓ, where 1≦x≦3; SOₓ, where 1≦x≦2; CO; CO₂, and at least one hydrocarbon.

72. The sensor system according to claim 49, wherein the plurality of nanostructures is thermally stable in a range from about 500° C. to about 800° C.

73. A method of controlling a combustion process in a combustion chamber, the method comprising the steps of:
a) providing at least one sensor for detecting gases to the combustion chamber, wherein the sensor comprises: at least one electrode pair, the electrode pair comprising a first sensing electrode and a second reference electrode, wherein each electrode comprises a plurality of nanostructures, the nano structures comprising at least one electrocatalytic material, and an electrolyte layer disposed between and separating the first sensing electrode and the second reference electrode;
b) generating an output signal from the at least one electrode pair, wherein the output signal is proportional to a concentration of at least one gas in the combustion chamber;
c) communicating the output signal to a control system; wherein the control system comprises a feedback loop; and
d) controlling at least one combustion parameter within the combustion chamber to control the combustion process, wherein the combustion parameter is controlled through the feedback loop based upon the output signal received from the at least one sensor.

74. The method according to claim 73, wherein the potential is created by reacting at least one gaseous combustion product with wherein the sensor generates an output signal that is proportional to the concentration of the at least one gas.

75. The method according to claim 73, wherein the step of controlling at least one combustion parameter comprises adjusting at least one of a fuel-to-air ratio, a combustion product pressure, a combustion chamber pressure a fuel pressure, an oxidizer pressure, a concentration of at least one gas, a fuel concentration, an oxidizer concentration, and combinations thereof.
